(19) United States
(12) Patent Application Publication
(10) Pub. No.: US 2017/0347643 A1
(43) Pub. Date: Dec. 7, 2017

(54) Collapsible hand-carried hunting blind

(71) Applicant: Rashid Sheedfar, Lexington, MA (US)

(72) Inventor: Rashid Sheedfar, Lexington, MA (US)

(21) Appl. No.: 15/608,971

(22) Filed: May 30, 2017

Related U.S. Application Data
(60) Provisional application No. 62/346,015, filed on Jun. 6, 2016.

(51) Int. Cl. A01M 31/02; E04H 15/00; E04H 15/30; E04H 15/44

(52) U.S. Cl. CPC A01M 31/025; E04H 15/30; E04H 15/001; E04H 15/44

(57) ABSTRACT

A blind for use by a hunter may be hand carried or statically mounted on the ground. A planar sheet of fabric is held taut by a metal hoop; the blind folds upon itself for storage. At least one view port is at the upper end of the blind. A handle on the rear of the blind comprises crossing straps; it is positioned between two side straps, so the blind may carried by one hand or by forearm. For static upright use, a pole slips into one of a widthwise or a lengthwise pocket on the rear of the blind. A segmented pole collapses to fit the dimension of a folded-upon-itself blind. Bows for shooting arrows are attached to the rear of the blind by a combination of clamps and straps. A lengthwise elongate opening that can be partly or fully closed by a flap enables shooting of an arrow through the blind.

This application claims benefit of provisional patent application Ser. No. 62/346,015, filed Jun. 6, 2016.

### TECHNICAL FIELD

The present invention relates to camouflage devices used by hunters and others who stalk wildlife, in particular, to hand carried blinds or shields which are optionally adapted for stationary use.

### BACKGROUND

Hunters, including those who seek to approach closely wildlife for purposes kill, capture, photography, or mere observation, have long used camouflage devices. Many such camouflage devices have surfaces with coloring and patterns that simulate the local natural environment, for example, trees and vegetation. Others camouflage patterns are along the lines of decoys; that is, they represent (sometimes in stylized fashion) an image of a prey bird or mammal.

In one simple approach, a hunter wears clothing which blends in with the surroundings. In another familiar approach, a hunter hides behind or within a static structure familiarly called a blind; sometimes referred to as a shield. Since at least the 17^{th} century, hunters have used hand carried blinds; for example, a piece of cloth or hide has been stretched over a frame, and there is a hole through which the hunter may shoot a gun.

In one approach to prey, a hunter seeks to stay immobile and lets the prey come to him or her. Some static blinds are assembled at a site, there to remain. Such blinds can range from the simple to elaborate, offering different degrees of roominess, circumscribing of camouflage, and protection from the elements. Other static blinds are temporarily structures which are collapsible for transport. For example, such a blind might be constructed along the same lines as a camping tent: one or more fabric sheets run between tube, rod or cable supports.

When using a bow and arrow, the limited range of such weapon necessitates that a hunter is close to the prey at the time of shooting. For example, a typical hunter may seek to be no more distant than 50 yards, more preferably 25 yards, from the prey. Obviously, a firearm shooter will also increase chance of success by being close to prey. Thus, hunters may want to use a mobile blind, namely, a hand-carried or weapon-mounted blind, so as to be able to approach the wildlife closely while carrying a weapon. If the hunter is moving through wooded or brushy terrain, it may be desirable that such a mobile blind at least not be much larger than the hunter's body; optionally, some hunters may prefer that the upper body only is shielded. Hand carried or weapon mounted small blinds are currently known; some blinds have umbrella like configurations; others may be constructed along the lines of a wind-kite, having light weight fabric running from and to interconnected light weight rods.

A hunter may want to wait at a fixed location with use of camouflage until such time as the prey comes into the hunter's vicinity, so the hunter can then hand carry the blind and approach the prey more closely. For comfort and to enable some movement while waiting for the prey to come to the hunter's locale, a blind is desirably large compared to the body size of the hunter.

To summarize, given their different uses, a mobile or hand-carried blind is desirably small in dimension whereas a static blind is comparatively large, all relative to an average size hunter. Those competing objectives suggest that a hunter use both a static blind and a hand carried blind. But it is not attractive for a hunter to be encumbered in carrying more than one kind of blind; and one objective of the present invention is to provide a blind that can serve both uses.

Since hunters often endure adverse weather conditions, a blind should be capable of resisting such, and in general it should be durable and strong. In tension with such a goal is a common desire to have light weight blind and a good price. Other important factors include the portability of a blind to a point of use and the compactness of storage of a blind when not in use.

There are a number of portable blinds known in the prior patent art. As mentioned a kite-like construction is known: In such braces may run across the blind form the center, in the center in the form of an X or right angle cross. Other portable blinds expand and collapse in the same general way as do rain umbrellas. Blinds have been made so they are attachable to a bow or cross bow; and such blinds have been provided with a window through which an arrow can be fired. Also known are static blinds which are in essence flat plates setting on edge, propped up by poles running from the surrounding terrain.

There is need for further improvements in blinds, to meet the foregoing complexity of needs, some of which compete with others.

### SUMMARY

An object of the present invention is to provide a device which camouflages a hunter from wildlife that the hunter is stalking, which device enables the use of a bow and arrow, cross bow, firearm, or possible other weapon; and which blind may be used as a stationary blind or as a hand-carried or weapon carried-shield. A further object is to make such device collapsible for compact storage and carrying when not in use. A still further object is to have a device which is economic to manufacture and durable.

In accord with the invention, blinds may generally be hand carried during use; and, depending on the features of the particular blind: blinds may optionally be used in static position where a pole supports the blind so it is nominally upright; and, the rear side of a blind may be attached to a compound bow or a cross bow so the hunter can view prey and shoot arrows through and opening in the blind. In preferred embodiments of such blinds, the blind comprises a sheet that lies in a plane; and the sheet is held taut by a circumscribing hoop. For compact storage or shipment such a blind with hoop may be folded upon itself into a nominally disk shape configuration.

In exemplary embodiments of blinds of the present invention: There is a port in the sheet near the top the blind and at the nominal center of the blind is a handle for carrying the blind with the length axis nominally vertical. To enable alternative use as a static shield where the blind is supported by a pole, a first pocket is attached to the rear of the sheet above the mid-length of the blind and a second pocket is attached to the rear of the blind, offset from the center length axis of the blind. A preferred pole is comprised of a multiplicity of segments held together by an internal elastic cord. In one mode, the pole is straight and an end is inserted in the first pocket to hold the blind so the length axis is nominally upright. In a second mode, the pole is bent so it has a V-shape, and the apex of V-shape is inserted into the second pocket, to hold the blind with its width axis generally upright. When the pole comprises four segments it may be folded upon itself into four parallel portions, with the length the folded pole about equal to or less than the diameter of the compact disk shape into which the blind is folded as mentioned in the preceding paragraph, thus allowing compact storage of the two components.

In other exemplary embodiments of blinds of the present invention: The sheet of the blind has an opening centered on the length axis. The opening has a length axis direction dimension greater than the width axis dimension and the top of the opening is preferably arch shaped. Two clamps are permanently or detachably fastened to the rear of the sheet of the blind; one above and one below the opening. Each clamp has a C shape body portion, the concavity of which is partially or wholly lined with a layer of hook and loop fastener system. Portions of the two limbs of a compound bow, spaced apart by the bow riser fit into the each clamp concavity, held there by a layer of hook and loop fastener system attached to the limb portions. Thus, the bow is attached to the rear of the blind and the hunter carrying the bow can both see and shoot an arrow through the opening. The bow and blind may be disengaged conveniently by sufficient pull-force. In another embodiment, a riser strap runs around the riser and limb of a bow, to hold the bow to the blind, with or without the foregoing engagement with the C shape clamp body. In still other embodiments, a blind comprises and opening with a flap portion of sheet. When the flap is open, a compound bow can shoot an arrow through the opening. When the flap is closed, the opening is converted into a round port, so the hunter can use the blind by hand carrying it or with a cross bow.

In still exemplary embodiments of blinds of the present invention: A blind has a handle in the nominal center of the rear of the blind for carrying the blind with one hand; the handle comprises a vertical strap and a horizontal strap. There are also two side straps that widthwise-bracket the handle. Thus a hunter may optionally slip his or her forearm under the vertical strap of the handle and then under one of the side straps, then being able to carry the blind mounted on the forearm and leaving the hand of said forearm free for holding a weapon.

In all embodiments, additional features may be present, including: straps may be spaced apart along one or both of the lengthwise sides of the rear of the blind to enable a hunter to hold the blind when the blind is oriented with the lengthwise axis horizontal while the hunter crawls along the ground; hook and loop fastener system portions may be spaced apart on the front of the blind, so a hunter may attach a second sheet or portions to the front of the blind; and ligaments may run generally widthwise on the front of the sheet, for holding vegetation to the front of the blind.

Blinds of the present invention are suited for production for reasonable costs, are simple to use and effective in being adapted to a multiplicity of hunter needs.

The foregoing and other objects, features and advantages of the present invention will become more apparent from the following description of preferred embodiments and accompanying drawings.

### BRIEF DESCRIPTION OF THE DRAWINGS

FIG. 1 is a rear elevation view of an embodiment of blind of the present invention.

FIG. 2 is a front elevation view of the blind of FIG. 1.

FIG. 3 is a partial view of the rear of the blind of FIG. 1, showing the center panel and handle.

FIG. 4 is a perspective view showing one way in which a hunter may hand-hold a blind like that shown in FIG. 1.

FIG. 5 is a partial cross section through the edge of the blind shown in FIG. 1.

FIG. 6 is a perspective view of a simplified blind like that of FIG. 1, in its use configuration.

FIG. 7A shows a progressive stage in the folding upon itself of the blind of FIG. 6.

FIG. 7B shows the blind of FIG. 6 after folding is complete, when the blind has a compact configuration for storage or transport.

FIG. 8 is a partial perspective view of the lower portion of an embodiment of blind which has pockets to enable static mounting.

FIG. 8A is a view like FIG. 8, showing how a center panel comprising a handle may be removably attached to the sheet of a blind.

FIG. 8B is a view like FIG. 8, showing a center panel is a flap which is connected along one edge to the sheet of a blind, to enable opening and closing of an opening in the center of the blind.

FIG. 9A shows a segmented pole having an elastic cord center.

FIG. 9B shows the pole of FIG. 9A in V-shape configuration

FIG. 9C shows the pole of FIG. 9A configured as four parallel members.

FIG. 10 is a side elevation view, showing the blind of FIG. 8 mounted vertically on terrain with a pole of FIG. 9A as support.

FIG. 11 is a perspective view of the blind of FIG. 8 mounted horizontally on terrain with a pole of FIG. 9B as support.

FIG. 12 is a perspective view of a blind and a mating compound bow that is capable of shooting an arrow.

FIG. 13 is a partial horizontal cross section of the blind in FIG. 12, showing the blind mated with the bow.

FIG. 14 is a perspective view of a blind that has a crossbow holder, along with portions of a crossbow.

FIG. 15 is a partial side elevation cross section view the blind of FIG. 14, showing a crossbow attached to the blind by a holder.

FIG. 16 is an exploded view of a blind having a multiplicity of the elements shown in other embodiments, indicating how a blind may be customized to a user's particular needs.

FIG. 17 is an exploded view of a blind suited for being either hand-held or mounted on a compound bow, having an arch shape opening that can be closed by a flap panel, so it becomes a smaller round opening.

### DESCRIPTION

The disclosure of U.S. provisional patent application Ser. No. 62/346,015, filed Jun. 6, 2016, of which this application claims benefit, is hereby incorporated by reference. The term “hunter” is used often herein to refer to a user of a blind. The term will comprehend those who do not seek to kill wildlife and other prey, for example those who only seek to closely observe prey.

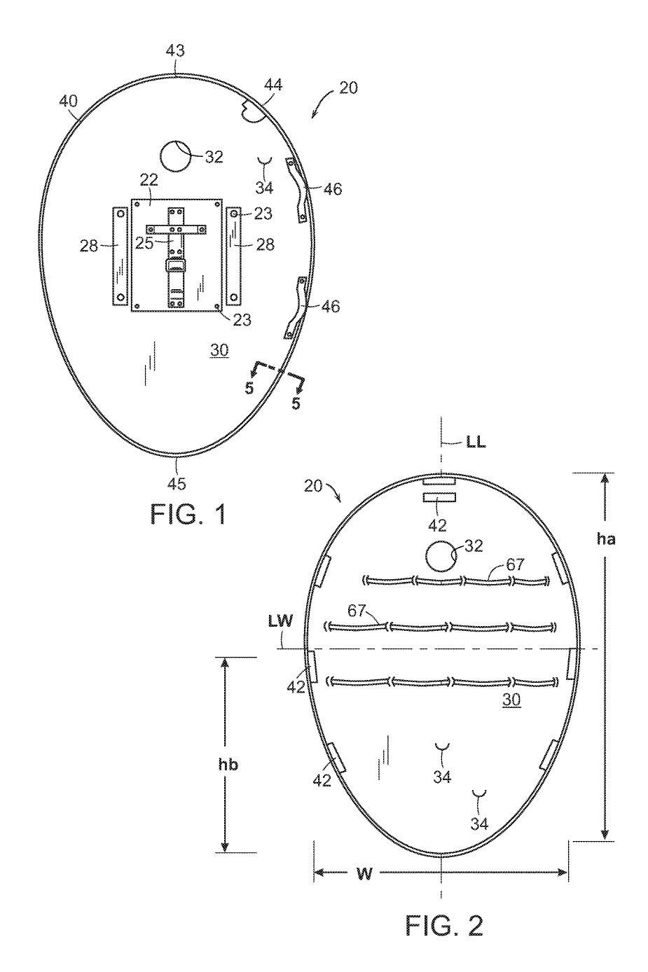

FIG. 1 shows the rear of blind 20 and FIG. 2 shows the front of blind 20, an embodiment of the present inventions. Blind 20 has a generally oval shape rim 40, a top 43, a bottom 45, a central length axis LL and a central width axis LW. Opposing lengthwise sides which are curved, optionally more nearly straight than shown, run between the top and the bottom. Other blinds of the present invention may be characterized as having a generally rectangular shape with rounded ends.

Blind 20 comprises a sheet 30 of fabric, preferably about 500-600 denier woven polyester fabric having a PVC coating which inhibits fraying and imparts water resistance. The sheet fabric preferably has a finish which provides the front face of the blind with a camouflage pattern, alternatively an image of a game animal, with or without associated camouflage. In another alternative, the fabric surface comprises brightly colored images of abstract items such as stars, swirls, and other objects on a white background. Such a surface has been found effective in approaching birds such as chukhar partridge, using the particular methodology described near the end of this description.

Various elements of the blind, which are described below, may be attached to sheet 30 or to each other using a combination of rivets 23 or adhesive. Optionally, and often more preferably, use is made of a hook and loop fastener system (often called a Velcro fastener system), which enables the elements to be selectively removed or replaced, so the configuration of a blind may be tailored to the desires of a particular user. Elements of a blind may be alternatively attached to the sheet of the blind or to each other (as applies) by such as sewing, heat sealing, ultrasonic bonding, or other well-known methods.

Spaced around the periphery of the blind are patches 42, each of which is one of either the hook portion or loop portion of a fastener system. Patches 42 enable a user to change the appearance of the front of the blind by removably attaching a further piece of fabric to the sheet front surface—including one or more high visibility hunter-orange panels, when required for safety reasons.

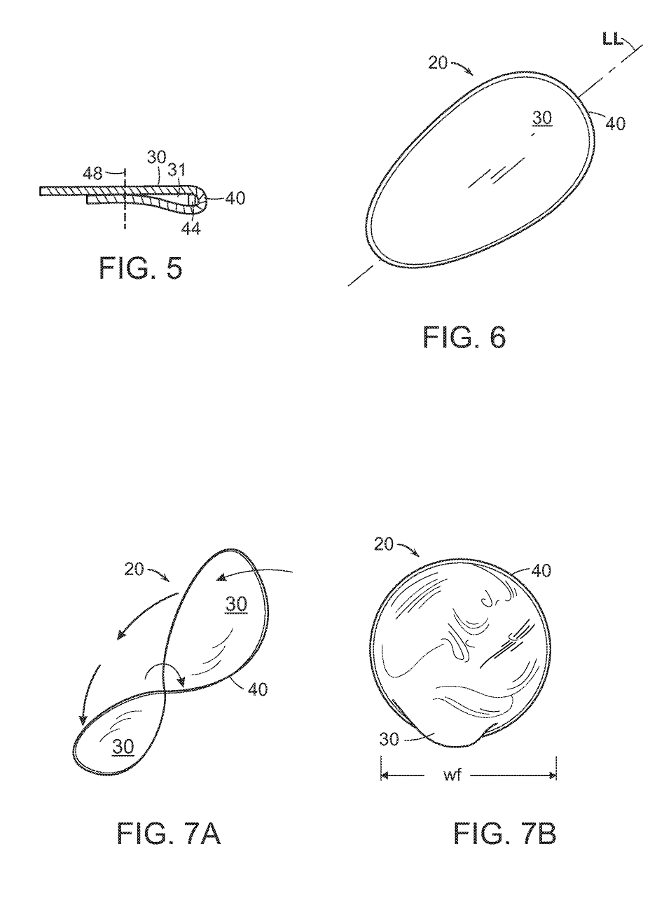

Sheet 30 is held taut in the use configuration of the blind due to its dimensions and to the presence of flexible spring steel hoop 44, which is revealed at the cutaway at the top right of FIG. 1 and in the cross section of FIG. 5. Hoop 44, which has a generally rectangular cross section is captured within a pocket 31 comprised of folded over fabric that runs around the rim 40 of the blind. Line 48 in FIG. 5 indicates a circumscribing stitching or adhesive line. Exemplary blinds may weigh from 1 to 3 pounds, which is a desirable low weight.

In certain alternative embodiments of the invention, rather than a hoop, the rim of the sheet of a blind may be held taut by another arrangement of rigid members. For example, although perhaps difficult to implement while making use of some features of the present invention, struts may run in a grid pattern or an X pattern as shown in U.S. Pat. No. 5,944,041 of Kitchens and U.S. Pat. No. 7,594,514 to Fereghetti et al., the disclosures of which are hereby incorporated by reference.

Embodiments of blind 20 have one or more ports, such as port 32, so the hunter can see the terrain beyond the blind and any wildlife. When there is a single port 32, as shown in FIGS. 1, 2 and 4, the port is located along the length axis above the midpoint of the central width axis, that is, in the portion of sheet 30 which is near the top of the blind. Ports alternatively may have shapes other than the round shapes which are shown. Referring to FIG. 2, blind 20 comprises a sheet 30 which preferably has a plurality of scallop shape incisions 34 that enable wind to push aside the flap created by each incision, thereby lessening the wind load on a blind. A hunter also may optionally look at prey through one of the openings defined by an incision 34, by pushing away the flap of material which borders the incision.

Blind 20 optionally comprises a multiplicity of ligaments 67 which run generally transverse to the length axis LL. See FIG. 2. Each ligament is connected to the front face of the sheet of the blind at spaced apart points. Thus, vegetation such as branches with leaves, reeds, straw, etc. may be slipped into the spaces between the ligament and the front face of the sheet, to enhance the camouflage effectiveness of blind 20. For clarity of illustration, only a few of incisions 34 and ligaments 67 which might be present are shown in FIG. 2 and these features are not shown in the drawings of other embodiments.

In FIG. 1, along the right edge of the rear face of blind 20 is a pair of spaced apart fabric handles 46, which a hunter may grasp to hold the blind when, in this embodiment, the right edge of the blind is disposed on the surface of terrain with the width axis W extending upwardly. See FIG. 11. Using handles 46, a user may crawl laterally with respect to the perceived direction of wildlife, dragging the blind as he or she crawls. Like handles may be disposed along the opposing lengthwise edge of the blind.

Blind 20 comprises a center panel 22, preferably made of sturdy fabric that is permanently or removably attached to sheet 30, to give strength and stiffness to the central portion of the sheet. A center panel may have a shape other than the rectangular shapes shown herein, within the generality of the invention.

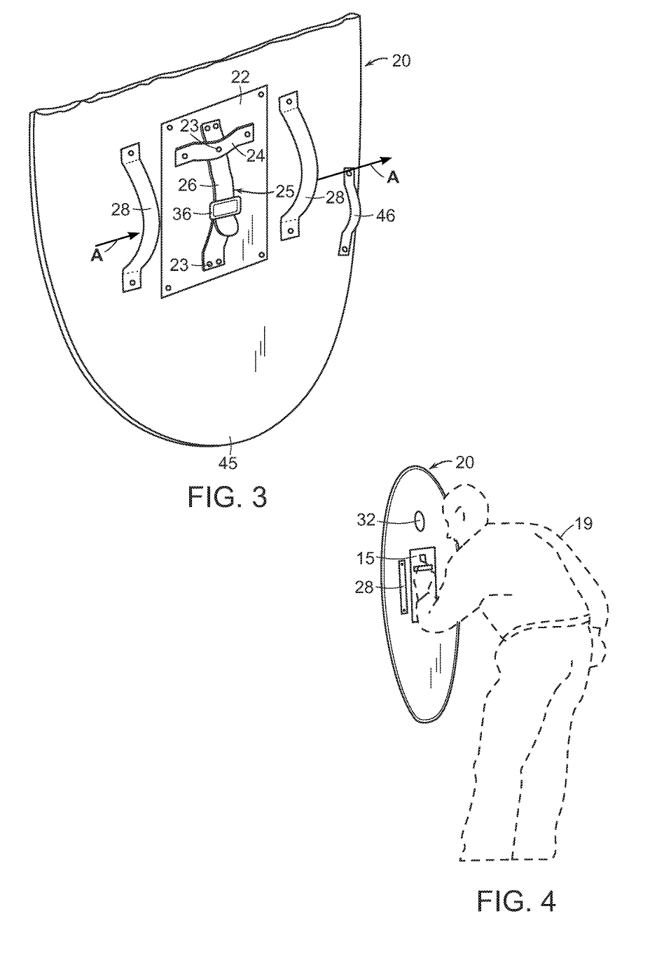

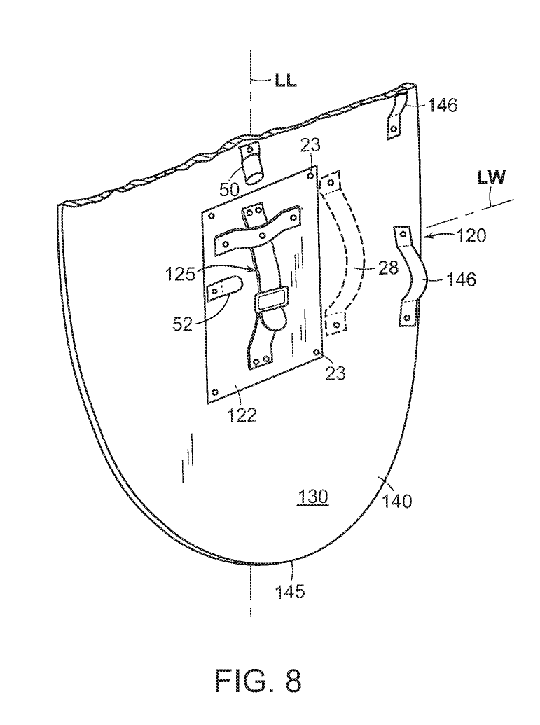

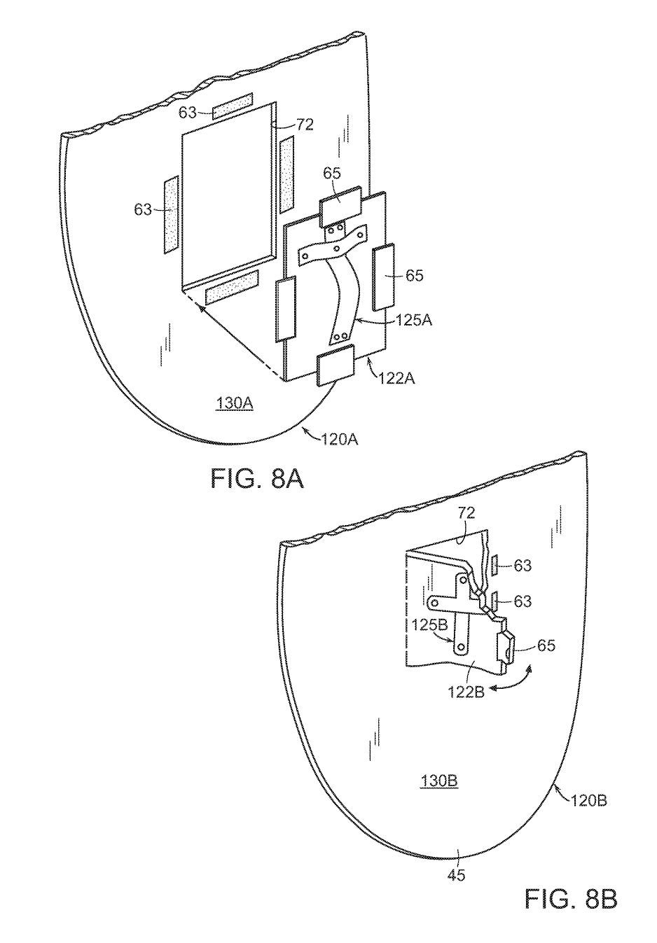

In FIG. 1 to FIG. 4, and in FIG. 8, blind 20 comprises handle 25 that is affixed to panel 22, preferably in the nominal center of the panel. Handle 25 comprises horizontal strap 24 and vertical strap 26 that are secured to each other. See FIG. 3 in particular. The handle “cross” configuration and its attachment to the panel, and thus to the sheet of the blind, enables a user to control well the angular rotation of the blind in the plane of the sheet, as well as in the fore-aft plane, compared to a single element handle, such as a lengthwise or widthwise running strap. Handles at the center of the blind which have different configurations may be employed. Depending on the shape of a blind and the distribution of weight about the central axes, a handle (and other centrally located elements of a blind which are described below) may preferably not be located precisely in the center of a blind/sheet, for balance and feel of handling a blind. Thus, elements are said to be centered in exemplary embodiments, but use of the term “central” and like terms in the claims should be construed to encompass elements that are in proximity to the center and not exactly at the center.

When length axis LL of a blind is vertical, the nominal center of strap 26 of handle 25 is preferably located on the sheet of the blind so that the center is at an distance hb from the bottom of the blind which is at about 50 percent of the blind total length ha (height, when the blind is hand carried). In other embodiments including those discussed below, horizontal centerline of a central panel, of the center of a handle affixed to a center panel, will more preferably be at an distance hb which is more than about 50 percent and less than about 70 percent of ha.

Exemplary blinds of the present invention are generally oblong and may approximate a rectangular shape or a tapered oval shape. Blinds may have different lengths ha, according to their intended use and the features of a particular blind type. An exemplary blind 20 that is particularly suited for hand carrying and attachment to a bow, may have a length ha of about 45 inches and a width w of about 32 inches. As shown in FIG. 4, a hunter 19 exemplarily holds blind 20 with his left hand grasping the handle 25. The hunter is able to look through port 32 and view the wildlife he seeks. With the shield shown in FIG. 4, a hunter's legs could be visible to wildlife unless, as is often the case, the hunter is standing in tall grass, low shrubs, etc. Further, hunters will often tend to assume a crouch. In other instances, it is found acceptable not to shield a hunter's legs with the blind when the hunter is erect.

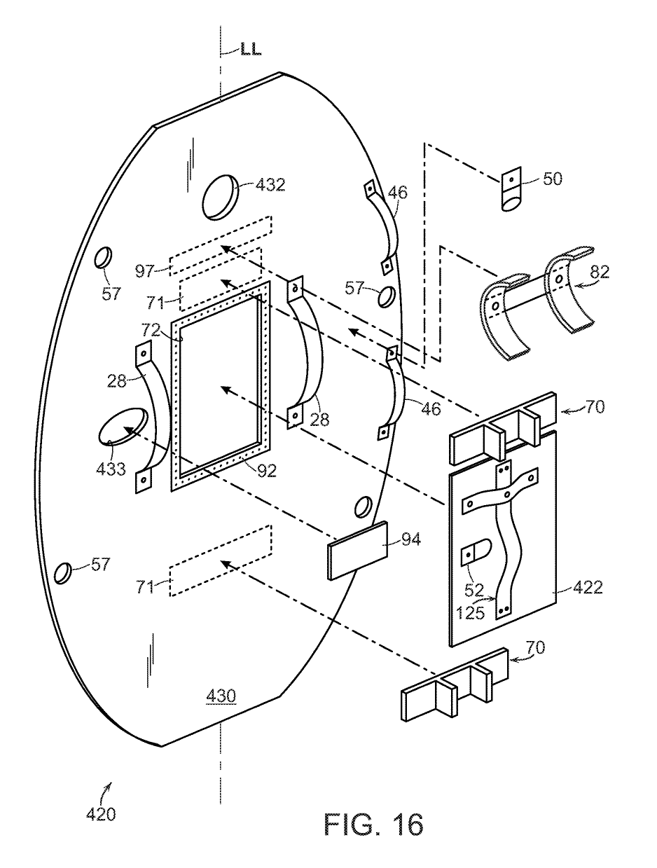

With reference to the lower-portion fragment of blind 20 shown in FIG. 3, strap 26 of handle 25 preferably comprises two pieces of material, preferably having a heft associated with leather or heavy canvas. More preferably the two pieces of strap 26 are connected at buckle 36, which enables adjustment of the length of strap 26 and thus the size of handle 25, to fit a particular hunter's hand. Alternatively, as shown in FIG. 8A and FIG. 16, the handle is not adjustable.

The rear side of blind 20 preferably has two side straps 28 attached to sheet 30, between which the handle 25 is centered. Instead of holding the blind only by means of handle 25, a hunter may alternatively slip his or her forearm through the opening under vertical strap 26 of the handle 25 and the opening under one of the side straps 28, as indicated by the arrows A in FIG. 3; thus freeing the hunter's hand of that forearm for such as holding a bow. In an alternate embodiment, side straps 28 may be secured to a panel 22 which is wider than the panel shown in FIG. 3. Side straps 28 may have buckle connections like strap 25 for adjustability.

FIG. 8A is an exploded view, much like the unexploded view of FIG. 8. FIG. 8A shows the rear side of the lower portion of blind 120A. In FIG. 8, panel 122 is shown as attached by rivets 23 to the rear of sheet 130; and thus it is not readily detachable and here is called “permanently attached.” FIG. 8A shows an embodiment of blind 120A comprising sheet 130A and panel 122A comprising handle 125A. Panel 122A is readily detachable from the sheet; panel 122A either fits within the opening 72 of sheet 130A or overlaps the edges of the opening. Four tabs 65 each comprising the hook portion or the loop portion of a hook and loop fastener system (an exemplary one of which is a commercial Velcro brand system) are permanently attached to the panel, extend outwardly from the edges of the panels. Four patches 63 comprising a mating loop portion or hook portion of the fastener system are permanently attached to the rear surface of sheet 130A, to align with the tabs 65 when the panel is put in place as indicated by the dashed arrow line. In variations on the foregoing, the tabs 65 are attached to the front face of a panel 122A which is larger than that pictured in FIG. 8A; and fewer or more tabs may be used. In alternative embodiments, a panel may be attached on the front of the sheet.

FIG. 8B is also a view like that of FIG. 8, showing blind 120B which comprises sheet 130B. Center panel 122B, comprising a handle 125B, is in the form of a flap or door and is preferably made of fabric which is integral with the fabric of sheet 130B. Flap panel 122B is shown partially open and partly cut away, and may move as indicated by the arrow, to either fully expose opening 72 or fully close it off. When the flap is closed, exemplary hook and loop portions 63, 65 mate to hold the free edge of the flap in place.

A feature of preferred blind 20, which has a hoop running around the rim, is that it can be folded upon itself for compact transport and storage; such folding is facilitated by the hoop. FIG. 6 shows in front perspective view an essential blind 20 in its working configuration. FIG. 7A shows by means of arrows how blind 20 may be twisted and folded upon itself. FIG. 7B shows blind 20 in its final folded configuration, where the upper portion of rim 40 now overlies the lower portion of rim 40 and sheet 30 is loosely gathered within the mated rim portions. The blind has assumed a disk-like shape which has a nominal diametrical dimension wf. As described below, a pole that optionally may be used with the blind can be configured so it has a compact folded configuration, the length of which is about the same as the diametrical dimension of the folded blind. In the generality of certain embodiments of the present invention, a blind having a hoop at the rim of the sheet of the blind may have an alternative construction which does not facilitate it being collapsible upon itself.

The next portion of this description describes how an embodiment of blind may be both carried as just described, or alternatively may be used when stationary on the surface of terrain, i.e., it may be used as a static blind, where the rim 140 at either the bottom or the side of the blind rests on the terrain. In each instance, a pole 60 holds a leaning blind at a preferably steep angle to the local plane that is tangent to the earth surface. While such a blind is slanted, for simplicity it is referred to here as being (nominally) “upright.” Preferably, a blind 120 which is intended for substantial static use will typically be somewhat larger than the blind described in connection with FIG. 4. For example, an exemplary blind intended for both static use and manual carrying may have a length ha of about 60 inches and a width w of about 40 inches.

FIG. 8 shows blind embodiment 120, comprising sheet 130 and rim 140. The blind has a center panel 122 and handle 125 in accord with above descriptions. There may be two straps 28, one only of which is shown in phantom. Optionally there are handles 146, like previously described handles 46. Pocket 52, sometimes called the side pocket, has a pole-receiving opening that faces to the right in FIG. 8; pocket 52, is attached to the left side of panel 122. Pocket 50, sometimes called the top pocket, has a pole-receiving opening that faces downwardly in FIG. 8. Pocket 50 is attached to sheet 30 just above panel 122. In an alternative embodiment, pocket 50 is attached to a portion of handle 125 or to a portion of center panel 122. Preferably, when the center length axis of a blind is vertical, pocket 50 is affixed to the blind at an elevation which is above the mid-height elevation, preferably at an elevation which is more than 50 percent and up to about 80 percent of the total height ha.

FIG. 10 is a side elevation view showing how blind 120 in combination with preferred pole 60 mounts statically, with the bottom 145 resting on the surface 64 of the local terrain. The upper end of pole 60, which is configured as a straight rod, sets within pocket 50 and the lower end of pole 60 sets on the surface 64. The length axis LL of blind 120 slopes rearward, pressing onto pole 60.

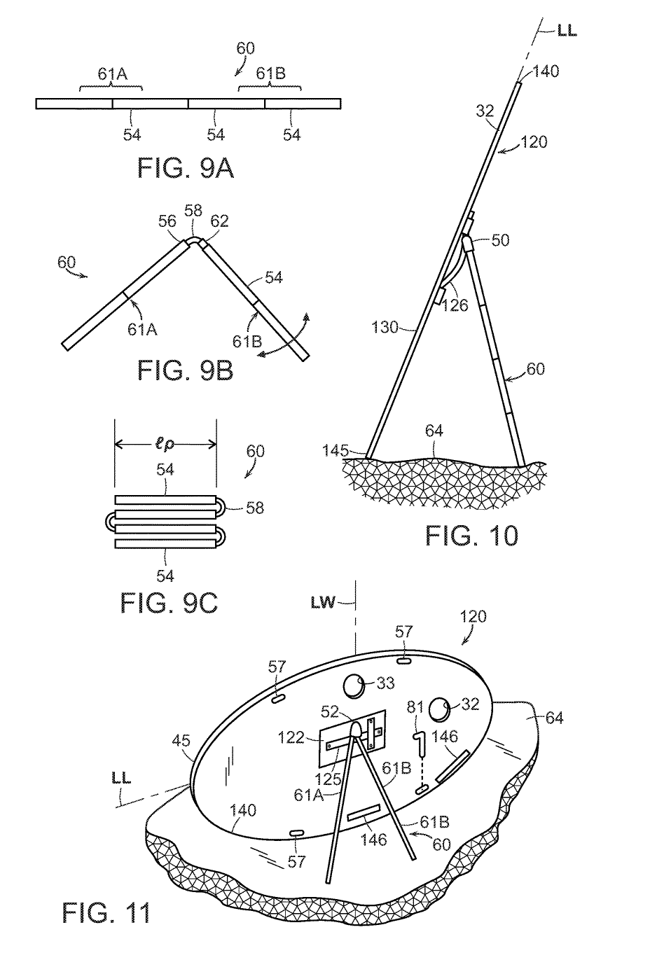

With reference to FIG. 9A, preferred pole 60 is comprised of four round cross section tubular segments 54 that are held together by spring tension force of an internal elastic cord 58, shown in FIG. 9B; the cord runs from end to end within the four segments. In alternative embodiments of the invention, a pole may have only two segments and segments may be non-round. In pole 60, one end 62 of each segment is necked down so it slips within the bore of the mating opposing end 56 of the adjacent like segment. Poles like pole 60 are commercially available, but as described below there is preferably a particular relationship between the lengths and number of segments of a pole 60 of the present invention and the width wf of the folded configuration of a blind, as shown in FIG. 7B.

FIG. 9B shows how pole 60 is bendable into a V-shape structure comprised of first leg 61A and second leg 61B, so the pole is useful in connection with the assembly embodiment of FIG. 11, where the blind lengthwise axis LL is nominally parallel to the plane of the earth. The arrow in FIG. 9B indicates how the angle of the V-shape may be adjusted. It will be further appreciated that each leg 61A, 61B may be further folded on itself, to provide the pole with a configuration comprising four nominally parallel segments, as shown in FIG. 9C. The length lp of each segment 54 is preferably chosen so that the length is not insubstantially larger than width wf of the folded blind shown in FIG. 7B. That enables a folded blind and a folded pole to be put in the same compact envelope for transport or storage.

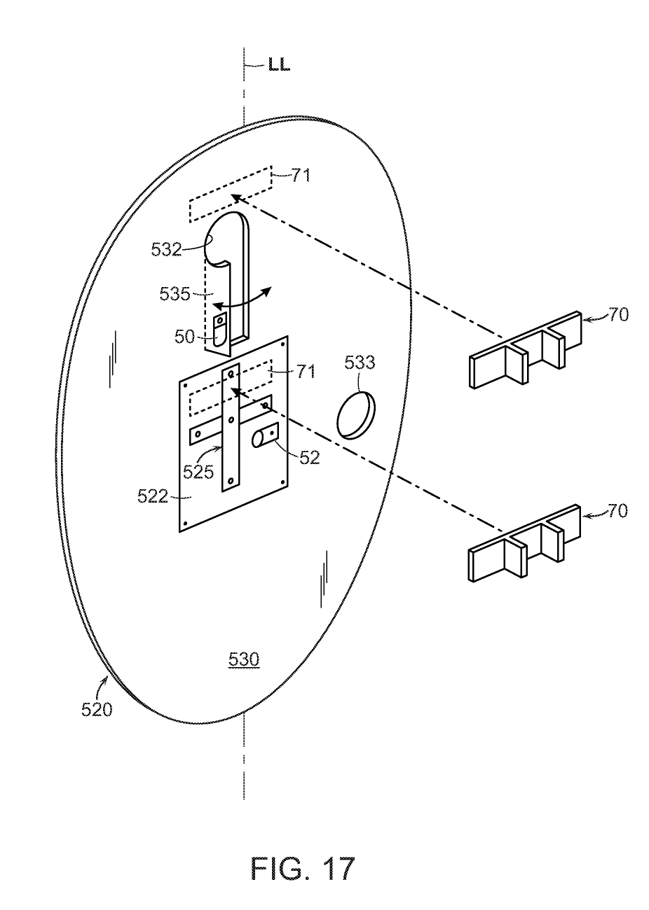

FIG. 11 shows in perspective view another way in which blind 120 mounts statically, with the longer side-defining portion of rim 140 resting on the surface of the terrain 64. The blind is shown in combination with pole 60, which now has a V-shape. The blind is in a generally upright configuration, where the width axis LW slopes rearwardly relative to the local tangent plane of the earth; and the blind presses against the two legs 61A, 61B of pole 60. The apex of the V-shape pole is contained within the interior of pocket 52, which pocket, as shown in FIG. 8, nominally lies along width axis LW and is off center from length axis LL. Referring to FIG. 11, the pole 60 thus is engaged with the rear side of the blind at an elevation which is higher than the mid-width of the blind. Blind 120 is shown now with the addition of second port 33, so that a hunter who is crouching behind the blind might better see prey than when using port 32. See also FIG. 16 and FIG. 17. A blind may additional side pockets spaced apart along the length of the blind, more than one pole may be used to support such a blind when it lies on a side.

In either of the static installations shown in FIG. 10 or FIG. 11, when needed to resist wind or inadvertent jarring, blind 140 may be staked to the surface of the earth by one or more ground stakes 81 which run through a grommet opening 57. One or more ground straps (e.g., ropes, not shown) may run from grommet openings 57 at the higher blind edge to stakes or weights on the terrain. Alternatively, ground straps with releasable clamps that grasp the rim of the blind may be used.

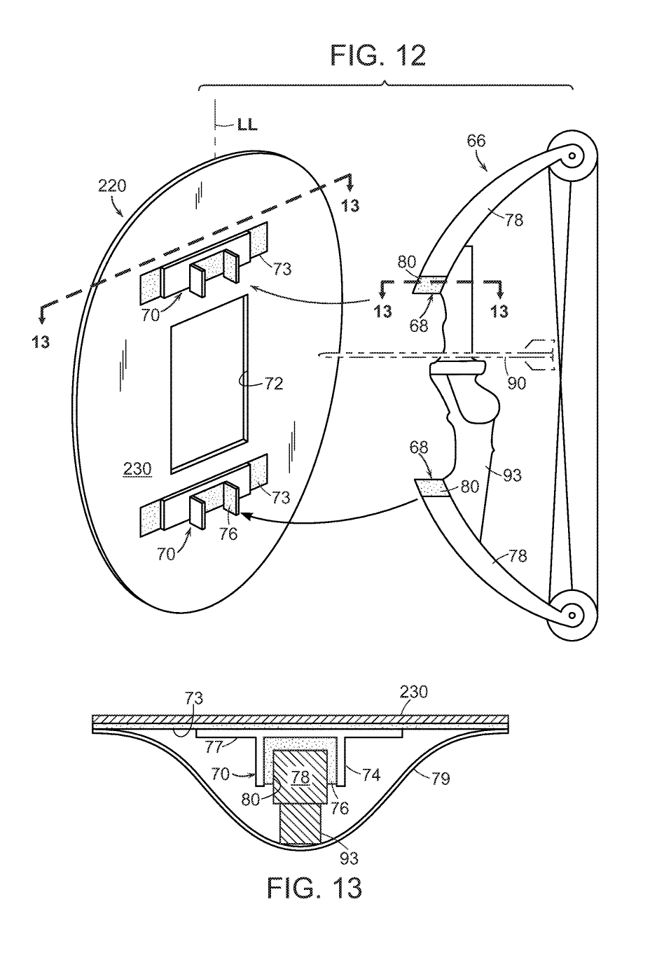

FIG. 12 is a perspective view of blind embodiment 220 showing how a blind may be configured for attachment to a compound bow 66. As indicated by the curved arrows in FIG. 12 each limb portion 68 of the bow is received and removably held within a clamp 70 that is affixed to sheet 230 of blind 220. The exemplary bow shown in FIG. 12 is of the commonly known reflex bow configuration; it comprises riser 93 that a hunter grasps when preparing to shoot an arrow. Attached to the upper and lower ends of the riser are opposing side limbs 78 which are spring-flexed when the arrow is drawn back within the bow, preparatory to shooting. Arrow 90, shown in phantom, lies along the centerline of the compound bow, loosely in contact with riser 93.

Blind 220 has a lengthwise central axis LL and comprises sheet 230 which has opening 72. The length of the opening is greater than the width. Above and below the opening 72 are clamps 70 which are attached permanently or removably to sheet 230 (upon which sheet there may be a re-enforcing panel, as desired, not shown). Clamps 70 are disposed along length axis LL of the blind, one on either side of opening 72. FIG. 13 is a partial horizontal cross section view of the apparatus of FIG. 12, now showing a bow and blind that are mated and secured to each other, when limb ends of the bow are engaged with the clamps on the rear of the blind.

As can be seen from FIGS. 12 and 13, each preferred clamp 70 (which is made of a resilient plastic or metal) comprises a nominally C shape cross section body 74 that is affixed to stiffener 77 that is attached for use to the rear of sheet 230. The C shape body 74 has a concavity which is surfaced with material 76 that is either the hook portion or the loop portion of a hook and loop fastener system (e.g. a Velcro fastener system). In alternative embodiments, only the sides or only the bottom of a concavity may have the Velcro type material.

Limbs 78 have portions 68 which are at least partially encased in material 80 that is either the loop portion or the hook portion of a hook and loop fastener system, for mating C shape body and associated material 76 of the clamp. Thus when the limb portions 68 and clamps are pushed firmly into engagement, the blind because attached to the bow. The blind can later be easily removed from attachment to the bow by applying sufficient force to separate the hook and loop fastener portions. This system avoids the necessity or ensuring the sufficient tightness of straps which alternatively may be used. In other embodiments of the invention, the limb portions which are surfaced with fastener system material may be further from the centerline of the bow that are the portions 68 shown in FIG. 12, which are those nearest the centerline of the compound bow.

When a stiffener 77 of a clamp is removably attached to the rear of sheet 230, as shown in FIG. 12 and FIG. 13, the stiffener is preferably attached to hook and loop material 73 which is itself secured to the rear surface of sheet 230 as by adhesive or stitching. FIG. 13 also shows an optional exemplary riser strap 79 that may be used, to enhance the engagement between the bow and blind. Riser strap 79 comprises a length of material having a hook and loop fastener surface that runs around the riser and limb of the bow to secure the bow to the rear surface of the blind; the strap 79 runs from opposing widthwise ends of material 73 that is on sheet 230. In an alternate embodiment, when a riser strap is used, the concave body of a clamp may not be omitted, and front face only of limb portion 68 will be secured by hook and loop means only to the center portion of the clamp stiffener.

Thus, when the bow and the blind are put together as just described, the blind becomes mounted on the bow and by holding the bow appropriately a user may use the combination to camouflage the user and stalk a prey; and at the appropriate time the user can shoot arrow 90 through opening 72 In the generally of the invention, a blind as just described may be alternatively attached to other types of bows that are well known, and future variants. While the limb portions 68 referred to above are preferably those portions of limbs which are the ends nearest to the centerline of the bow, in alternative embodiments the limb portions which are engaged with clamps may be portions that are further away from the centerline.

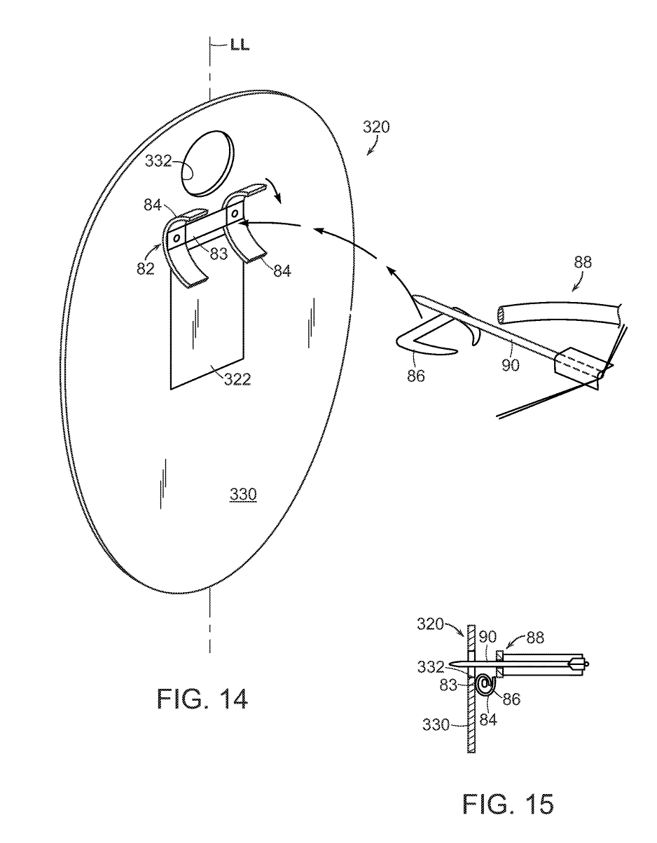

In another use of a blind of the present invention, a crossbow may be attached to a blind. FIG. 14 shows simplified blind embodiment 320 along with a suggestive portion of a crossbow 88 holding an arrow 90, both in phantom. The dashed curved arrow in the Figure shows how the cross bow mates with the blind. Crossbow 88 which may be a common commercial product, comprises stirrup 86, a familiar feature. Crossbow holder 82 of blind 320 comprises backing plate 83 which is attached to sheet 330 of the blind preferably by hook and loop fastener, alternatively by adhesive, stitching, adhesive etc. Spaced apart straps 84 of holder 82 that are attached to the backing plate are shaped and disposed to wrap around stirrup 86 and removably to adhere to each other, such as by hook and loop fastening.

FIG. 15 is a fragmentary vertical cross section of blind 320 showing the stirrup 86 of the crossbow 88 as it is captured by holder 82. Holder 82 is positioned vertically on sheet 330 so that the arrow 90 that is ready to shoot from cross bow 88 sticks through port 332 of sheet 330. Port 332 has sufficient dimension so that the hunter can see the target through the port when the arrow is positioned in the port ready to be launched. Blind 320 may have in addition selected features shown in connection with other embodiments of blinds, as suggested by the dashed outline of panel 322.

FIG. 16 is an exploded view of blind 420 indicating how a multiplicity of elements that have been described may be attached to the sheet 430 of the blind in various combinations, according to the needs or desires of the user. Preferably a hook and loop fastener system is used for detachably-attaching the elements in the field. Alternative attachment means previously mentioned may be used. Sheet 430 has an opening 72 which is surrounded by hook portion or loop portion 92 of a fastener system, so that panel 422 may be secured to the sheet to close the opening and enable blind 70 to be held by handle 125 on the panel; or to enable a pole to be inserted in socket 52 for ground-support. (In an alternative embodiment, socket 52 might by itself be separately attached to sheet 430.) Socket 50 may be attached to sheet 430 for pole-support with the blind axis LL vertical.

When a user wishes to use blind 420 with a compound type bow and arrow, clamps 70 are attached to the rear of sheet 430 at locations 71. When a user wishes to use blind 420 mounted on a cross bow, holder 82 is attached at location 97 and the straps of the holder are wrapped around the stirrup of a cross bow. The shooter can then looks and shoots through port 432. When the shooter disposes the blind with the length axis LL horizontal to the terrain surface, port 433 may be used. Patch 94 may be used to close port 433; alternately a like patch may be used to close port 432. A previously mentioned one of the side straps 28 may be used in combination with handle 125, to carry the blind.

FIG. 17 shows the rear side of blind embodiment 520 which is particularly configured for bow hunters and is optionally useful for gun hunters or others. Blind 520 has a construction preferably like that other blinds described herein. There is a first elongate opening 532 nominally centered on the length axis LL; it has an arch shape upper portion. Circular port 533 is located to one side of the length axis LL.

Center panel 522 carries handle 525 and side pocket 52; the center panel may be permanently or detachably secured to sheet 530. Clamps 70, suited for receiving the limbs of a compound bow as previously described, are attachable by hook and loop fastener or other means to the rear surface of sheet 530, at locations 71, shown in phantom. (In the particular embodiment shown, when the clamp is at the lower location 71, it bridges the vertical strap of handle 525.) Optionally, blind 520 may also have the features which enable attachment of a cross bow, including holder 82.

Flap 535 preferably is a portion of sheet 530 or it may be a separate piece of material that is attached to the sheet. In both instances the flap is constructed so as to act like a door, as indicated by the curved arrow, thus to either expose fully the lower portion of opening 532 of to close it off. Flap 535 preferably has a curved upper edge, so that when the flap is closed (and held in place by hook and loop fastener system not shown), opening 532 becomes a round port. Preferably, vertical pocket 50 is attached to the rear facing surface of flap 535, and side pocket 52 is attached to the center panel, to enable static use of the blind. The aforementioned side straps 28 may be also present.

Thus, when blind 520 has the flap 535 closed, the blind may be used as a hand held shield, with the user looking through the port comprising the upper portion of opening 532 or the side port 533. When the flap is open, a compound bow may be attached to the blind by clamps 70, and prey may be viewed and an arrow may be shot through the opening 532.

The methodology of the present invention is implicit in the foregoing descriptions of the article embodiments and how they are attached, carried, or statically mounted, and how they facilitated shielding a hunter from view or prey which potentially enabling shooting. In short, the methods of the present invention which include providing an article as described above, include the combination of some or all of (a) carrying a blind by hand or forearm and peering through a port; (b) statically mounting a collapsible blind in nominally upright fashion the length axis or the width axis vertical, and using a segmented collapsible pole; (c) attaching a blind to the limbs of a compound bow using detachable connecting means, such as clamps or straps; (d) using a blind with a compound bow by folding open or removing a portion of the sheet, optionally a central panel comprising a handle, and attaching the limbs of a bow to the blind; and (e) using a blind having an elongate opening which is partly closable by a flap where, when the flap is open a compound bow attached to the blind and arrows are shot through the opening, and when the flap is closed, a substantially round port remains in the sheet of the blind and the hunter either hand carries the blind or attaches the blind to a cross bow and shoots through the port which remains.

Included in the present inventions is the following method of using a hand carried or weapon-mounted blind: A user/hunter moves directly toward the prey, employing slow intermittent or continuous steps while a blind of the present invention is positioned between the hunter and the prey. The hunter holds in space a blind so that it blocks from visibility of the prey the preponderance of the hunter's body, optionally the hunter's legs are blocked as well. The hunter may have a slight or full crouch. Any lateral motions of the hunter and the blind are minimized. In practice, this method is found effective in enabling a hunter to closely approach prey even though to a human being the camouflage pattern may not be very realistic, and even if when scrutinized by a human being from the viewing point of the prey, it seems that portions of the hunter's face or other body portions might be visible to the prey.

The invention, with explicit and implicit variations and advantages, has been described and illustrated with respect to several embodiments. Those embodiments should be considered illustrative and not restrictive. Any use of words such as “preferred” and variations suggest a feature or combination which is desirable but which is not necessarily mandatory. Thus embodiments lacking any such preferred feature or combination may be within the scope of the claims which follow. Persons skilled in the art may make various changes in form and detail of the invention embodiments which are described, without departing from the spirit and scope of the claimed invention.

I claim:

1. A blind having a length, a central length axis, a width, a central width axis, a front, a rear, a top and a bottom lying along the lengthwise axis, and opposing straight or curving lengthwise sides spaced apart along the width axis, the blind shaped for partially or fully blocking from view of wildlife a user when the blind is either carried by the user or statically positioned on the surface of terrain, comprising:
a sheet lying in a plane, having a rim and at least one port located in proximity to the top of the blind user;
a center panel, permanently or removably attached to the sheet proximate the center of the sheet;
a handle attached to the center panel, to enable a user manually to control the orientation of the blind;
a first pocket having an opening facing generally toward one of the lengthwise sides, the pocket located along the length axis nearer to the top of than to the bottom of the blind and attached to the sheet or to the center panel or to the handle, the pocket having an opening facing generally toward the bottom of the blind; and,
at least one second pocket attached to the rear of the sheet, to the center panel, or to the handle, the pocket located along the width axis, and offset from the central length axis.

2. The blind of claim 1 in combination with a pole comprised of at least two interconnected segments, wherein the pole may be configured (a) as a straight rod, one end of which is receivable in the first pocket for holding the blind with its length axis nominally upright, or (b) as a V-shape rod having two legs which meet at an apex, the apex receivable in the at least one second pocket for holding the blind with the width axis nominally upright.

3. The blind of claim 1 in combination with a pole comprised of at least four interconnected segments, so the pole may be configured (a) as a straight rod, one end of which is receivable in the first pocket for holding the blind with its length axis nominally upright, or (b) as a V-shape rod having two legs which meet at an apex wherein two pole segments comprise each one of the two legs, the apex receivable in the at least one second pocket for holding the blind with the width axis nominally upright.

4. The claim of claim 3 wherein the blind comprises a hoop running around and secured to the rim of the sheet, and wherein the blind is collapsible by folding upon itself by twisting and bending of the hoop, so the blind assumes a folded disk like configuration with a nominal disk diameter wf; wherein each of said pole segments has a length which is less than or about the same as the dimension of diameter wf.

5. The blind of claim 1 wherein the handle comprises a first strap running parallel to the central length axis and a second strap running parallel to the central width axis, the straps crossing each other and attached to each other at the crossing point.

6. The blind of claim 5 further comprising: two spaced apart side straps, attached either to said center panel or to the sheet adjacent said panel, each side strap located on an opposing side of said handle along the central width axis, and each strap shaped for entry of a user's forearm which also passes through the length axis strap of the handle.

7. The blind of claim 1 wherein the sheet of the blind has a second at least one port located nominally along the width axis near to one side of the blind than the other side of the blind; further comprising: at least two spaced apart straps attached to the sheet in proximity to the rim at one of said lengthwise sides of the blind, to enable a user, attached either to said center panel or to the sheet adjacent said panel, each side strap located on an opposing side of said handle along the central width axis, and each strap shaped for entry of a person's forearm that also passes through the handle

8. The blind of claim 1 wherein the first pocket location is between 50 and 75 percent of the length axis distance from the bottom.

9. The blind of claim 1 further comprising one or more of
(a) a plurality of straps spaced apart along one or both of the lengthwise sides of the rear of the blind, so a user may hold the blind when the blind is oriented with the lengthwise axis horizontal; and
(b) portions of a hook and loop fastener system spaced apart on the front of the blind, so a user may attach a second sheet or second sheet portions to the front of the blind.

10. A blind having a length, a central length axis, a width, a central width axis, a front, a rear, a top and a bottom lying along the lengthwise axis, and opposing straight or curving lengthwise sides spaced apart along the width axis, the blind shaped for partially or fully blocking from view of wildlife a user when the blind is either carried by the user or statically positioned on the surface of terrain, comprising:
a sheet lying in a plane and having a rim and at least one opening centered on the length axis and located nearer to the top of the blind than to the bottom of the blind, the opening a length greater than width, vertically opposing side running lengthwise edges;
a first clamp positioned between the opening and the top; and,
a second clamp positioned between the opening and the bottom;
wherein each clamp is detachably or permanently attached to said sheet or another portion of the blind; each clamp comprising a C shape portion having a concavity shaped for receiving a portion of the limb of a bow, each said C shape portion lying along the length axis of the blind, and each C shape portion lined with a portion of a hook and loop fastener system.

11. The blind of claim 10 in combination with a bow of the compound type which comprises two spaced apart limbs connected by a central riser, each limb having a portion near the central riser to which is attached with a portion of hook and loop fastener system configured to mate with a portion of hook and loop fastener system which lines one of said C shape portions on the blind; wherein each limb portion is positioned within a C shape portion of a clamp, so the blind thereby is held to the bow by said mated hook and loop fastener portions.

12. The blind of claim 11 wherein the limbs are mated with the clamps, further comprising: at least one riser strap having a length running widthwise relative to the blind, opposing lengthwise ends detachably attached to the sheet on either side on one of the C shape portion of a clamp, the strap running around portions of the bow to help keep the bow fastened to the blind.

13. The blind of claim 11 further comprising a flap, integral with or attached to one of said lengthwise running edges of the opening, the flap sized to run widthwise across the opening, for closing off part or all of the opening;
wherein the opening has an arch shape upper end; and wherein the flap has a concave shape upper end, so that when the flap is positioned to cover the lower part of the opening, a circular opening in the blind is formed.

14. The blind of claim 8 further comprising:
a detachable or permanently attached central panel, located further from the top of the blind than is said opening;
a handle attached to said central panel, the handle comprising a first strap running parallel to the central length axis and a second strap running parallel to the central width axis, the straps crossing each other at a point and attached to each other at the crossing point.

15. The blind of claim 14 wherein the blind comprises a hoop running around and secured to the rim of the sheet; the blind collapsible by folding upon itself by twisting and bending of the hoop, so the blind assumes a folded disk like configuration.

16. A blind having a length, a central length axis, a width, a central width axis, a front, a rear, a top and a bottom lying along the lengthwise axis, and opposing straight or curving lengthwise sides spaced apart along the width axis, the blind shaped for partially or fully blocking from view of wildlife a user when the blind is either carried by the user or statically positioned on the surface of terrain, comprising:
a sheet lying in a plane, having a rim and at least one port located in proximity to the top of the blind user;
a hoop running around, and secured to, the rim of the sheet;
a center panel, permanently or removably attached to the sheet in proximity to the center of the sheet; and,
a handle attached to the center panel, to enable a user manually to control the orientation of the blind in the plane of the sheet and at angles thereto, the handle comprising a first strap running parallel to the length axis and a second strap running parallel to the width axis, the straps crossing each other and attached to each other at the crossing point.

17. The blind of claim 16 further comprising a clamp permanently or detachably fastened to the rear of the sheet further from the center width axis than said at least one port, the clamp comprising two spaced apart straps for holding the stirrup of a cross blow to the sheet in a configuration which enables a user holding the cross bow to shoot an arrow through the at least one port.

18. The blind of claim 16 further comprising a first side strap and a second side strap attached to the rear of the blind, wherein said handle is centered between the side straps, each strap having a length nominally aligned with said length axis of the blind, each side strap located relative to the first strap of the handle and the rear of the sheet a space shaped for receiving a user's forearm that is slipped through the handle and then a space formed by one of the side straps and the rear of the sheet.

19. A method of hunting using a blind of claim 18 which comprises: passing a user's hand and forearm under the vertical strap of the handle and then only through a space defined by one of the side straps.

20. A method of hunting using the blind and compound bow combination of claim 11 which comprises: pressing the limbs of the bow into the C shape portions of the clamps, to detachably fasten the bow to the blind; then carrying the bow and thereby the blind while looking through the opening in the sheet of the blind, and optionally shooting an arrow from the bow through the opening; then pulling the bow away from the blind to separate the bow from the blind; then optionally collapsing the blind for transport.
